(19) United States
(12) Patent Application Publication
(10) Pub. No.: US 2007/0206880 A1
(43) Pub. Date: Sep. 6, 2007

(54) Coupled Bayesian Framework For Dual Energy Image Registration

(75) Inventors: Yunqiang Chen, Plainsboro, NJ (US); Hao Wu, Greenbelt, MD (US); Tong Fang, Morganville, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/563,815

(22) Filed: Nov. 28, 2006

Related U.S. Application Data
(60) Provisional application No. 60/741,300, filed on Dec. 1, 2005.

(51) Int. Cl. G06K 9/32; G06K 9/00

(52) U.S. Cl. 382/294; 382/132

(57) ABSTRACT

A computer implemented method for joint image registration and reconstruction of a plurality of images includes providing the plurality of images, modeling the plurality of images, including reconstructing bone and soft-tissue in respective images of the plurality of images, performing a hierarchical free-form registration of models of the plurality of images to determine a jointly registered and reconstructed image with successive accuracy adjustment according to a registration error, and outputting the registered and reconstructed image.

### CROSS-REFERENCE TO RELATED APPLICATIONS

This application claims the benefit of Provisional Application No. 60/741,300 filed on Dec. 1, 2005 in the United States Patent and Trademark Office, the content of which is herein incorporated by reference in its entirety.

### BACKGROUND OF THE INVENTION

1. Technical Field

The present disclosure relates to image registration, and more particularly to a coupled Bayesian framework for image registration in which the registration and reconstruction reinforce one another.

2. Description of Related Art

Image registration finds various applications in computer vision and medical imaging. Different registration methods have been developed for rigid or non-rigid deformations. Some recent research extends image registration to fuse images from different modalities.

It remains a challenging task to achieve robust and accurate registration in X-ray dual energy imaging. Dual images obtained with X-rays at different energy spectra have different appearances, which complicates the designing of appropriate similarity measurements for image alignment. Mutual information has been proposed for multi-modality image registration, but it is difficult to achieve the needed accuracy for good reconstruction of the bone and soft-tissue layers.

Therefore, a need exists for a system and method for coupled Bayesian framework for image registration in which the registration and reconstruction can reinforce each other.

### SUMMARY OF THE INVENTION

According to an embodiment of the present disclosure, a computer implemented method for joint image registration and reconstruction of a plurality of images includes providing the plurality of images, modeling the plurality of images, including reconstructing respective bone and soft-tissue in respective images of the plurality of images, performing a hierarchical free-form registration of models of the plurality of images to determine a jointly registered and reconstructed image with successive accuracy adjustment according to a registration error, and outputting the registered and reconstructed image.

### BRIEF DESCRIPTION OF THE DRAWINGS

Preferred embodiments of the present invention will be described below in more detail, with reference to the accompanying drawings:

FIG. 1 is a diagram of a system according to an embodiment of the present disclosure;

FIG. 2 is a flowchart of a method according to an embodiment of the present disclosure;

FIG. 3 is an exemplary embodiment of an image formation model;

FIG. 4 is a diagram of exemplary Gaussian pyramid structures;

FIG. 5 is a set of exemplary images of a dual energy chest x-ray; and

FIG. 6 is a diagram of a system according to an embodiment of the present disclosure.

### DETAILED DESCRIPTION OF PREFERRED EMBODIMENTS

According to an embodiment of the present disclosure, a coupled Bayesian framework is implemented wherein registration and reconstruction reinforce one another. With the reconstruction results, accurate matching criteria are designed for aligning the dual images. Furthermore, prior knowledge of the bone and soft tissue can be exploited to detect poor reconstruction due to inaccurate registration; and hence correct registration errors in the coupled framework. A multiscale free-form registration method is implemented to achieve sub-pixel registration accuracy.

According to an embodiment of the present disclosure, a coupled Bayesian method implements an image formation model of dual energy imaging to solve image registration and reconstruction jointly.

Certain exemplary embodiments comprise a method, which can comprise determining an image of a bone-only or soft-tissue-only image of a predetermined physiological structure of a patient. The image can be determined based upon two sets of input images acquired with X-Ray of different spectra on the predetermined physiological structure of the patient. The image can be determined based upon an iterative method to compensate the movement of the predetermined physiological structure of a patient during the acquisition of these two sets of images. In certain exemplary embodiments, two images might be desired of a particular structure of a predetermined portion of an object, such as a physiological structure of a medical patient. In embodiments regarding the physiological structure of the medical patient, a bone only image that is substantially devoid of rendered soft tissue might be desired. Instead of and/or in addition to the bone only image, a soft tissue image might be desired that is substantially devoid of rendered bone. In certain exemplary embodiments, a relatively high energy spectrum can be used as an imaging technique to determine a first image, such as a substantially bone image. In certain exemplary embodiments, a relatively low energy spectrum can be used as an imaging technique to determine a second image, such as a substantially soft tissue image. The first image can comprise artifacts and/or a rather faint and/or deformed version of the second image, and/or the second image can comprise artifacts and/or a rather faint and/or deformed version of the first image. For example, the substantially bone image can comprise soft tissue artifacts and/or the substantially soft tissue image can comprise bone artifacts.

Certain exemplary embodiments can be adapted to utilize data associated with the first image to filter and/or subtract first image artifacts from the second image and/or the second data associated with the second image to filter and/or subtract second image artifacts from the first image. In certain exemplary embodiments, the object, such as the patient, can be at a different location in the second image as compared to the first image. Such a movement can result in motion artifacts as data associated with the first image is used to filter and/or subtract first image artifacts from the second image and/or data associated with the second image is used to filter and/or subtract second image artifacts from the first image. Certain exemplary embodiments can be adapted to iteratively determine a best estimate of the movement of the object based upon an initial iterative estimate of the first image and/or the second image. Certain exemplary embodiments can be adapted to utilize the best estimate of the movement of the object in an iterative determination of a best estimate of the first image and/or a best estimate of the second image.

The disclosure presents exemplary embodiments regarding X-ray imaging of patients. Additional embodiments can be realized in CT imaging, PET imaging, SPECT imaging, magnetic resonance imaging, radar imaging, laser imaging, sonar imaging, and/or any other imaging technology of animate and/or inanimate objects wherein images differ based upon energy and/or frequency spectra and image filtering and/or subtraction is desired, such as when physical movement of the object has occurred between the time the first image is generated and the time the second image is generated.

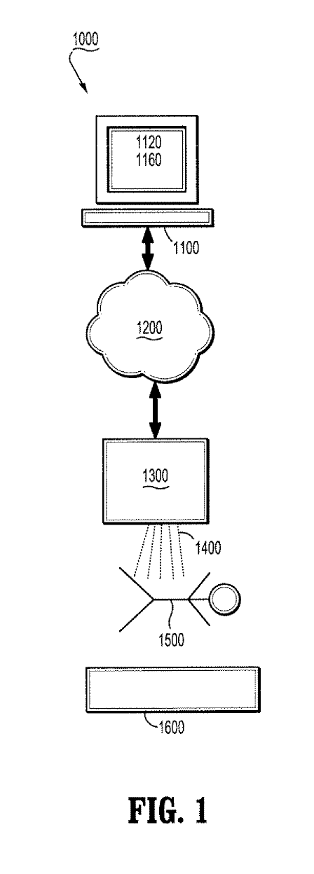

FIG. 1 is a block diagram of an exemplary embodiment of a system 1000, which can comprise an imaging device 1300. Imaging device 1300 can be any device adapted to provide an image, such as an image of a patient 1500. For example, imaging device 1300 can be an X-ray imaging device, and/or a computed tomography (CT) device. Imaging data can be obtained regarding patient 1500, such as via imaging device 1300, a device communicatively coupled thereto, and/or an independent detector 1600, utilizing reflected and/or absorbed emissions 1400 from imaging device 1300.

Imaging device 1300 and/or independent detector 1600 can be communicatively coupled to an information device 1100 directly and/or via a network 1200. Information device 1100 can comprise a user program 1160, which can be adapted to analyze, process, manage, align, and/or enhance image data from imaging device 1300. Information device 1100 can comprise a user interface 1120, which can be adapted to render image information associated with imaging device 1300.

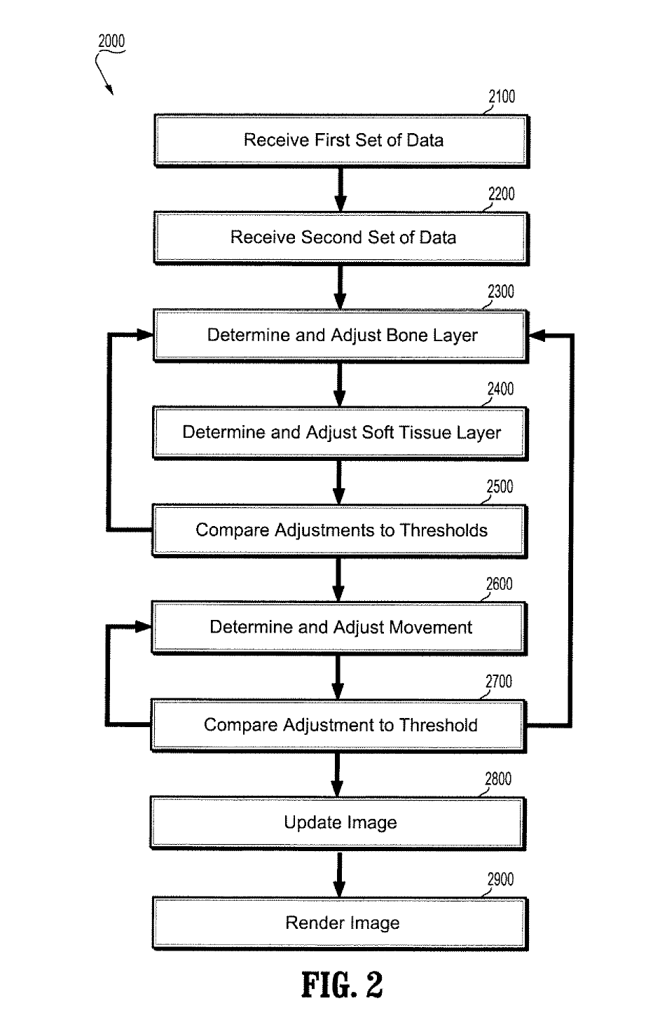

FIG. 2 is a flowchart of an exemplary embodiment of a method 2000. At block 2100, a first set of image data can be obtained and/or received from an imaging device, such as an X-ray device and/or a detector and/or an information device communicatively coupled thereto. The first set of image data can be of a predetermined physiological structure of a patient. For example, the physiological structure can be a head, neck, foot, leg, thigh, pelvic region, hip region, torso, abdominal region, neck, and/or spinal column, etc. of the patient. The patient can be any animal, such as a human, horse, cow, dog, cat, dolphin, fish, monkey, antelope, and/or bear, etc. The first set of image data can originate from the X-ray device. The X-ray device can be operated at a first energy spectrum. The first set of image data can have originated during a first time interval.

At block 2200, a second set of image data can be obtained and/or received from the imaging device. The second set of data can be of the predetermined physiological structure and can be received from the imaging device and/or the detector and/or the information device communicatively coupled thereto. The second set of image data can be of the predetermined physiological structure of the patient. The second set of image data can originate from the X-ray device. The X-ray device operated at a second energy spectrum. The second set of image data can have originated during a second time interval. The second time interval can be distinct from the first time interval.

At block 2300, a mathematical representation of a bone layer can be determined and/or adjusted. The mathematical representation of the bone layer can be determined, such as from prior knowledge about the statistical properties of the bone layer and/or based upon an identification of the physiological structure of the patient. The mathematical representation of the bone layer can be iteratively adjusted, based upon a movement of the patient in the second time interval relative to the first time interval, until the adjustment of the mathematical representation of the bone layer is below a first predetermined threshold. The mathematical representation of the bone layer can be adjusted and/or determined repeatedly, with each repetition based upon an iteration of an adjustment of a mathematical representation of a soft tissue layer. The adjustment of the mathematical representation of the bone layer can be repeated for each of a plurality of iteratively determined estimates of the mathematical representation of the soft tissue layer.

In certain exemplary embodiments, the mathematical representation of the bone layer satisfies some constraints which can be enforced by attempting to minimize one or more cost functions, such as following expression:
−log P(B)∝((1−e)∥B− B̅∥²+λₑe)
where:
P(B is a probability that the mathematical representation of the bone layer is correct;
e is a binary indicator of whether a pixel is located on an edge of the image;
B is the mathematical representation of the bone layer;
B̅ is an average characteristic of bone within a predetermined neighborhood; and
λₑ is a predetermined factor adapted to penalize edge points.

At block 2400, the mathematical representation of the soft tissue layer can be determined and/or adjusted. The mathematical representation of the soft tissue layer can be determined, such as from prior knowledge about the statistical properties of the soft tissue layer and/or based upon an identification of the physiological structure of the patient. The mathematical representation of the soft tissue layer can be iteratively adjusted, based upon the movement of the patient in the second time interval relative to the first time interval, until the adjustment of the mathematical representation of the soft tissue layer is below a second predetermined threshold. The mathematical representation of the soft tissue layer can be determined repeatedly, with each repetition based upon an iteration of the adjustment of the mathematical representation of the bone layer. The adjustment of the mathematical representation of the soft tissue layer can be repeated for each of a plurality of iteratively determined estimates of the mathematical representation of the bone layer.

In certain exemplary embodiments the mathematical representation of the soft tissue layer and/or the mathematical representation of the bone layer can be determined based upon constraints and/or joint moments shared between the mathematical representation of the bone layer and the mathematical representation of the soft tissue layer

In certain exemplary embodiments, the mathematical representation of the soft tissue layer satisfies some constraints which can be enforced by attempting to minimize one or more cost functions, such as following expression:
−log P(S)∝((1−e′)∥S− S̅∥²+λ′,e′)
where:
P(S) is a probability that the mathematical representation of the soft tissue layer is correct;
S is the mathematical representation of the soft tissue layer;
e′ is a binary indicator of whether a pixel is located on an edge of the soft tissue layer;
S̅ is an average characteristic of soft tissue within a predetermined neighborhood; and
λ′ₑ is a predetermined factor adapted to penalize edge points.

In certain exemplary embodiments, the mathematical representation of the bone layer and the mathematical representation of the soft tissue layer can be determined by attempting to minimize a cost functional:

$$C = {‖ {I}_{1} - a \cdot B - b \cdot S ‖}^{2} + {‖ {I}_{2} - c \cdot T ( B ) - d \cdot T ( S ) ‖}^{2} + {λ}_{1} ( ( 1 - e ) {‖ B - \overline{B} ‖}^{2} + {λ}_{e} e + ( 1 - {e}^{′} ) {‖ S - \overline{S} ‖}^{2} + {λ}_{e}^{′} {e}^{′} ) + {λ}_{3} MI ( B , S )$$

where:

At block 2500, an adjustment value associated with the bone layer can be compared to a first predetermined threshold. An adjustment value associated with the soft tissue layer can be compared to a second predetermined threshold. In certain exemplary embodiments the adjustment and/or threshold comparison of the bone layer and the adjustment and/or threshold comparison of the soft tissue layer can take place in separate algorithms and/or a common algorithm.

At block 2600, to achieve subpixel accuracy in non-rigid registration, a hierarchical free-form registration method with successive accuracy adjustment is designed and applied, wherein a movement of the patient can be determined, adjusted, and/or estimated. An estimate of the movement of the patient can be adjusted until the adjustment of the movement of the patient is below a third predetermined threshold. The estimated movement of the patient can be based upon the adjusted mathematical representation of the bone layer and/or the adjusted mathematical representation of the soft tissue layer. In certain exemplary embodiments, the adjusted movement of the patient can be determined via an updated movement of a Gaussian pyramid, a determination of a control mesh that attempts to minimize a cost, and/or a bilinear interpolation of control points of the mathematical representation of the bone layer and the mathematical representation of the soft tissue layer.

In certain exemplary embodiments, the adjusted movement of the patient is determined via an attempted minimization of an equation:
∥I₂−c·T(B)−d·T(S)∥²+λ₂∥T− T̅∥²
where:
I₂ is an image based upon the second set of image data;
c is a first constant reflecting attenuation of bone and/or soft tissue to X-rays over a predetermined spectrum;
T(B) is a measure of the adjusted movement of the patient related to the mathematical representation of the bone layer;
d is a second constant reflecting attenuation of bone and/or soft tissue to X-rays over the predetermined spectrum;
T(S) is a measure of the adjusted movement of the patient related to the mathematical representation of the soft tissue layer;
λ₂ is a predetermined constraint weighting factor;
T is the adjusted movement of the patient, and
T̅ is an average adjusted movement of the patient.

At block 2700, an adjustment value of the movement of the patient can be compared to a third predetermined threshold. In certain exemplary embodiments, the adjustment of the mathematical representation of the bone layer, the mathematical representation of the soft tissue layer, and/or the movement of the patient can be repeated until the adjustment of the mathematical representation of to the bone layer is below the first predetermined threshold, the adjustment of the mathematical representation of the soft tissue layer is less than the second predetermined threshold, and/or the adjustment of the movement of the patient is below the third predetermined threshold.

In certain exemplary embodiments, the determination, adjustment, and/or comparison to the third predetermined threshold of the patient movement can occur before, during, or after the determination, adjustment, and/or comparison of a respective adjustment to a respective predetermined threshold of:
the mathematical representation of the bone layer; and/or
the mathematical representation of the soft tissue layer.

A reconstructed image based on the mathematical representation of the bone layer and/or the mathematical representation of the soft tissue layer corresponding to the input images is output.

At block 2800, an image associated with the bone layer, the soft tissue layer, and/or the movement can be adjusted and/or updated. The image can be a renderable image and can be automatically determined. The image can be of the predetermined physiological structure of the patient. The image can be determined based upon the iteratively adjusted movement of the patient in the second time interval relative to the first time interval, the adjustment of the mathematical representation of the bone layer, and/or the adjustment of the mathematical representation of a soft tissue layer.

The image can be determined based upon the determined mathematical representation of the bone layer and the determined mathematical representation of the soft tissue layer, wherein each of the determined mathematical representation of the bone layer and the determined mathematical representation of the soft tissue layer can be determined based upon adjusting a cost functional that comprises a mutual information term that comprises bone information and soft tissue information. The image can be determined based upon an iterative algorithm adapted to determine the movement of the patient based upon the determined mathematical representation of the bone layer and the determined mathematical representation of the soft tissue layer.

The image can be determined based upon the determined mathematical representation of the bone layer and the determined mathematical representation of a soft tissue layer and an iterative adjustment of a movement of the patient until the adjustment associated with the movement of the patient is below a predetermined threshold. The cost function can be based upon the mathematical representation of the bone layer and the determined mathematical representation of the soft tissue layer.

At block 2900, the adjusted and/or updated image of the predetermined physiological structure can be rendered, such as via a user interface. The adjusted and/or updated image can be based upon the adjusted mathematical representation of the bone layer, the adjusted mathematical representation of the soft tissue layer, and/or the adjusted movement of the patient.

Image registration finds various applications in computer vision and medical imaging. Different registration methods can be utilized for rigid or non-rigid movements. Certain exemplary embodiments can be adapted to fuse images from different modalities.

Certain exemplary embodiments can be adapted to achieve a relatively robust and accurate registration.

Image registration for X-ray dual energy imaging can be challenging due to the overlaid transparent layers (i.e., the bone and soft tissue) and the different appearances between the dual images acquired with X-rays at different energy spectra. Moreover, subpixel accuracy can be desirable for good reconstruction of the bone and soft tissue layers. Certain exemplary embodiments can utilize a coupled Bayesian framework, in which the registration and reconstruction can effectively reinforce each other. With the reconstruction results, accurate matching criteria can be determined for aligning the dual images, instead of treating them as a multi-modality registration.

In certain exemplary embodiments, prior knowledge of the bone and soft tissue can be utilized to detect poor reconstruction due to inaccurate registration; and hence correct registration errors in the coupled framework. A multiscale free-form registration algorithm can be implemented to achieve subpixel registration accuracy.

In X-ray dual energy imaging, dual images obtained with X-rays at different energy spectra can have different appearances, which can complicate the designing of appropriate similarity measurements for image alignment. Mutual information can be utilized for multi-modality image registration. Achieving subpixel-accuracy for reconstruction of the bone and soft tissue layers can be a goal of dual energy imaging. Certain exemplary embodiments can utilize a coupled Bayesian method based on the image formation model of dual energy imaging to solve image registration and reconstruction jointly.

Dual energy imaging can improve upon single energy chest radiography, which can have relatively low sensitivity for detecting lung nodules or other subtle details due to the overlap of bone structures and soft tissue. Dual energy imaging can separate the bone and soft tissue from two X-ray images acquired at different energy spectra. Since attenuation coefficients of bone and soft tissue can follow different functions of the energy, the dual images can be weighted and subtracted to acquire separated soft tissue specific and bone specific images, thereby potentially improving evaluations of the lung nodules or pleural calcification.

Image registration can be important in a dual-exposure method, which can perform an image acquisition procedure at two different energy levels in two exposures and provides better image quality than a comparable one-shot method. A time gap between the two exposures can be about 200-300 ms, during which patient or anatomical motions and/or movements might result in motion artifacts in a weighted image subtraction. Certain exemplary embodiments can align the two images before subtraction. The dual images can be overlays of two layers (i.e., bone B and soft tissue S). A potential image formation model can be:
I₁=a·B+b·S
I₂=c·T(B)+d·T(S) (1)
where a, b, c, and d are determinable constants reflecting attenuation coefficients of the bone and soft tissue to the X-ray at different spectra. Based on the two observed images I₁ and I₂, a bone B and soft tissue S can be reconstructed and a non-rigid movement T can be determined.

In certain exemplary embodiments, where there is no substantial movement between the dual images, the bone and soft tissue can be obtained through weighted subtraction of I₁ and I₂:
B=(d·I₁−b·I₂)/(a·d−b·c)
S=(a·I₂−c·I₁)/(a·d−b·c) (2)

In certain exemplary embodiments, image registration can be a preprocessing step to align I₁ and I₂, followed by the weighted subtraction in Equation (2). However, problems that might arise in such a scheme can comprise:
The images I₁ and I₂ might have different appearances due to different attenuation coefficients. A simple similarity measurement might be difficult to determine to guide the registration process. Cross-correlation or mutual information might be used, but might assume only very general dependencies between the two images and neglect the image formation model of Equation (1). Such an approach might encounter difficulties in achieving a relatively robust registration with a relatively high accuracy.
Reconstruction of bone B and soft tissue S can be dependent on the accuracy of the non-rigid registration. Equation (2) indicates that any registration error can be amplified by 1/(a·d−b·c), which might be relatively large when the ratios of coefficients (a/c and b/d) are similar. Exemplary experiments show that subpixel accuracy can be desirable for good reconstruction.
The subtraction procedure in Equation (2) can assume aligned dual images. Registration error might not be corrected via Equation (2) Also, such a subtraction might not utilize prior knowledge of the bone and soft tissue (e.g., smoothness constraint and edge modeling), which might be helpful in image restoration.

Certain exemplary embodiments can comprise a coupled Bayesian framework to register the dual images and reconstruct the bone and soft tissue layers jointly. In the coupled framework, two processes can reinforce each other and can achieve more robust and accurate results. First, with explicit modeling of the bone and soft tissue, relatively accurate similarity measurements can be designed for the registration process instead of treating the dual images as from different modalities and/or relying on more difficult multi-modality registration techniques. Second, prior knowledge and constraints of the bone and soft tissue can be integrated to check the validity of the reconstruction results. Registration error that causes invalid reconstruction (e.g. highly correlated bone and soft tissue layers) can be detected and/or reduced in the coupled framework. To achieve subpixel accuracy in non-rigid registration, certain exemplary embodiments can comprise a hierarchical free-form registration algorithm with successive accuracy adjustment.

Image registration can be an ill-posed problem, in the sense that image registration can be under-determined and many possible solutions might exist. Image registration can be complicated for non-rigid registration. In certain exemplary embodiments, prior knowledge/constraints of the imaging process and possible movement can be utilized for relatively robust and relatively accurate registration methods.

A Bayesian framework can be utilized to incorporate various constraints based on prior knowledge. An objective of image registration might be to find a most probable movement T that attempts to maximize a posterior probability P(T|I₁,I₂). From Bayesian rule:

$$P ( T \vert {I}_{1} , {I}_{2} ) = \frac{P ( {I}_{1} , {I}_{2} \vert T ) P ( T )}{P ( {I}_{1} , {I}_{2} )}$$

where P(I₁,I₂) is a constant term with respect to T. Therefore, a maximum a posterior (MAP) solution to the registration problem can be obtained as follows:

$$T = arg {max}_{T} log P ( {I}_{1} , {I}_{2} \vert T ) + log P ( T )$$

where P(I₁,I₂|T) defines the similarity measurement to determine how well the movement T aligns the two images. For example, sum of squared difference (SSD) can be used as a single modality and mutual information term. P(T) can represent prior knowledge of the movement field T, e.g. smoothness thereof.

Dual energy imaging can be performed in two steps.

First, the dual images can be registered by a multimodality registration method. Then, a weighted subtraction in Equation (2) can be used to reconstruct the underlying bone and soft tissue layers.

A goal of dual energy imaging can be to reconstruct the bone and soft tissue layers. The subtraction procedure might assume no error in the registration. The procedure might attempt to reconstruct B and S to literally match every pixel of I₁ and I₂ based on T. A unique solution of B and S might be found, even if T is not well estimated, and/or no scheme is used to correct the registration error when the reconstruction is not good. Combining registration and reconstruction can be desirable to form a closed loop to adjust the registration result if the reconstructed bone and soft tissue layers are poor (e.g., highly dependent).

Without knowing the bone and soft tissue layers, defining a similarity measurement P(I₁,I₂|T) might be difficult, because the images are generated with X-rays at different energy spectra and have different intensity values even without movement. In certain exemplary embodiments, dual images can be treated as if each image is from a different modality and a similarity measurement can be determined based upon mutual information and/or a cross correlation. Those measurements might neglect the image formation model in Equation (1) and might assume only general dependencies in the dual images. Hence, the similarity measurements can be more susceptible to false matching when dealing with spatial variant bone and soft tissue layers.

In certain exemplary embodiments, registration and reconstruction can be addressed jointly. In certain exemplary embodiments, registration and segmentation can be solved jointly by coupled partial differential equations. Segmentation can be represented by a level-set function to separate the image into exclusive parts. In certain exemplary embodiments, the bone and soft tissue layers might be transparent and overlaid together to generate the acquired images. Hence, certain exemplary embodiments can model the underlying bone and soft tissue layers with two extra appearance templates and handle the layer reconstruction and the registration jointly.

Certain exemplary embodiments can be based on an image formation model of the dual imaging process and/or a coupled framework integrating registration and reconstruction together.

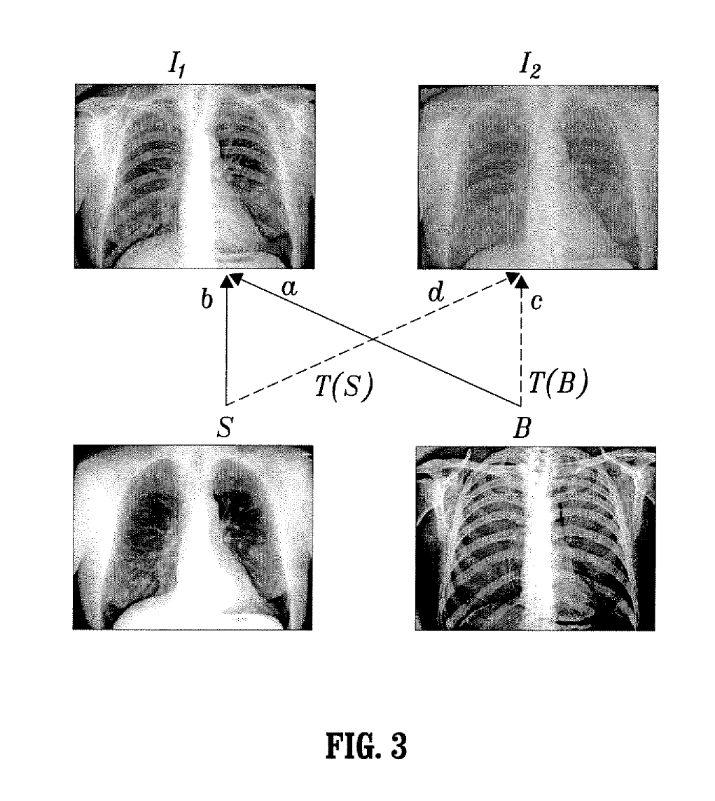

FIG. 3 is an exemplary embodiment of an image formation model, which can comprise dual images generated according to Equation (1). In certain exemplary embodiments, bone B and soft tissue S might not be observed directly. Instead bone B and soft tissue S can be overlaid with different coefficients to form images with different appearances. Considering the hidden variables B and S jointly during the registration process, certain exemplary embodiments can formulate the dual energy image registration as follows:

$$P ( T , B , S \vert {I}_{1} , {I}_{2} ) = \frac{P ( {I}_{1} , {I}_{2} \vert T , B , S ) P ( T , B , S )}{P ( {I}_{1} , {I}_{2} )} \qquad ( 3 )$$

Certain exemplary embodiments can assume that T, B and S are mutually independent, the MAP solution to this problem can be obtained by:

$$T = arg {max}_{T , B , S} log P ( {I}_{1} , {I}_{2} \vert T , B , S ) + log [ P ( T ) P ( B ) P ( S ) ] \qquad ( 4 )$$

This MAP solution leads to a conclusion that the registration and reconstruction can be solved jointly. The movement T, the bone B and the soft tissue S can and/or should be updated together to match the acquired dual images I₁ and I₂. The prior knowledge about the movement and the appearance of the layers (i.e., P(T), P(B) and P(S)) can be integrated to refine the reconstruction. For example, P(B) and P(S) can model the smoothness constraint with edge modeling and P(T) can regularize the smoothness of the movement field. In certain exemplary embodiments, if the reconstructed B and S do not satisfy the prior knowledge due to registration error, T can be updated and corrected to achieve an acceptable solution.

Furthermore, by introducing bone and soft tissue layers explicitly, the similarity measurement P(I₁,I₂|T,B,S) can be derived. Certain exemplary embodiments might not rely on the mutual information or cross correlation to judge the matching of the dual images even though they have different appearances. Assuming the imaging noise is zero mean Gaussian, a good estimation of B, S and T might allow a synthesis of the dual images and therefore minimize the following cost function:

$$- log P ( {I}_{1} , {I}_{2} \vert T , B , S ) ∝ {‖ {I}_{1} - a \cdot B - b \cdot S ‖}^{2} + {‖ {I}_{2} - c \cdot T ( B ) - d \cdot T ( S ) ‖}^{2}$$

This can be more accurate matching criteria than mutual information or cross correlation and less susceptible to false matching, and hence allows more robust registration with sub-pixel accuracy.

In certain exemplary embodiments, in the proposed coupled Bayesian framework, the registration and reconstruction can reinforce each other and can provide good results.

Based on the proposed coupled Bayesian framework, various prior knowledge or constraints can be utilized and can result in a relatively stable and physically meaningful registration and reconstruction result. In experiments, the following assumptions and constraints were made, which can be true in dual energy imaging:
The movement between the dual images (e.g., patient aspiration) can be modeled by a non-rigid dense movement field T. Certain exemplary embodiments can assume that the movement field is substantially smooth across the image. With this assumption, certain exemplary embodiments can choose the P(T) in Equation (4) as:
   −log P(T)∝∥T− T̅∥²
where T̅ is the average movement within the neighborhood (i.e., the low-pass filtered version of T).
The bone and soft tissue layers can and/or should satisfy the smoothness constraint with edge modeling. Let e be the edge map, where e(p)=1 means the corresponding pixel p is an edge point and the smoothness constraint can be and/or should be suppressed. To prevent all the pixels from being classified as edge points, λₑ can be used to penalize the edge points. Thus:
   −log P(B)∝(1−e)∥B− B̅∥²+λₑe)
   −log P(S)∝(1−e′)∥S− S̅∥²+λ′ₑe′)
where B̅ and S̅ are the average bone and soft tissue within the neighborhood.
Registration error can be a factor in poor reconstruction. In the coupled framework, misalignment can be corrected that can cause reconstruction errors. In certain exemplary embodiments, misaligned dual images cannot cancel out the bone or soft tissue and cause highly correlated artifacts in reconstructed bone and soft tissue layers. Hence, independent analysis between the bone and soft tissue can help detect and correct the registration error. In certain exemplary embodiments, Bayesian frameworks alone might not guarantee the independence constraint even though the independence is used to factorize the joint probabilities. Certain exemplary embodiments can and/or should explicitly enforce the independence by minimizing mutual information MI(B,S).

Using λₑ to control the weighting of each constraint, an objective function, C, to be minimized can be derived as follows:
C=∥I₁−a·B−b·S∥²+∥I₂−c·T(B)−d·T(S)∥²+λ₁=((I−e)∥B− B̅∥²+λₑe+(1−e′)∥S− S̅∥²+λ′ₑe′)+λ₂∥T− T̅∥²+λₑMI(B,S) (5)
The cost function of Equation (5) can be optimized using a variational approach in an iterative manner.

To initialize an exemplary algorithm, a rough registration can be determined based upon Harris corner detection on the dual images. Correspondence can be found based on the cross correlation in the neighborhood around the detected corners. Then the initial movement of each pixel can be approximated by a weighted average of the nearest four corners. Based on this movement field, certain exemplary embodiments can generate an initial reconstruction of the bone and soft tissue, using the weighted subtraction in Equation (2).

Certain exemplary embodiments can fix T and attempt to optimize B and S. For each pixel, certain exemplary embodiments can search within a search range B^{k+1}=B^{k}+δ₁ and S^{k+1}=S^{k}+δ₂ to find B^{k+1} and S^{k+1} that attempt to minimize the cost function in Equation (5).

Certain exemplary embodiments can then fix B and S and attempt to optimize movement field T. Certain exemplary embodiments can adopt a free-form movement model that is controlled by regularly distributed control points (i.e., rectangular grids). A hierarchical searching strategy can be used to optimize the movement model to achieve sub-pixel accuracy successively as explained in next section in detail. This optimization strategy can be described as following exemplary Algorithm 1:

Algorithm 1: Optimization Scheme

```
Data: Given Dual Energy images I₁,I₂.
Result: Reconstructed Deformation Field T, bone layer B and
soft-tissue layer S.
Use geometric based registration algorithm followed by
simple subtraction process to get T₀,B₀,S₀.
while ˜ stop do
  Fix T^{k}, find the B^{k+1}, S^{k+1}
  for each pixel p do
    In a search range −m≦δ₁≦m, −n≦δ₂≦n, for each
    pixel p, each term in Eq. (5) is computed
    corresponding to Bₚ^{k}+δ₁,Sₚ^{k}+δ₂ to find the optimal
    δ₁^{opt} and δ₂^{opt}. Update: B^{k+1}=B^{k}+δ₁; S^{k+1}=S^{k}+δ₂;
  end
  If ||B^{k+1}−B^{k}||²≦ε_{B} and ||S^{k+1}−S^{k}||²≦ε_{S} stop. Otherwise,
continue.
  Fix B^{k+1}, S^{k+1} find T^{k+1} to optimize the cost function in
  Eq. (5) using the hierarchical searching strategy
  described in Algorithm 2.
  If ||T^{k+1}−T^{k}||²≦ε_{T}, stop. Otherwise, continue.
end
```

In the above optimization scheme, the mutual information can be computationally expensive. Certain exemplary embodiments can approximate the entropy term, e g, H(X)=p(X)log p(X) by Taylor expansion:
x log x=x₀+(1+log x₀)x+O(x−x₀)²
where the entropy and joint entropy can be approximated by a summation within a neighborhood and hence can be calculated efficiently.

In certain exemplary embodiments, for each iteration, based on the refined bone B^{k} and soft tissue S^{k} from the previous iteration, the registration result T^{k+1} can be further refined.

Certain exemplary embodiments can utilize a non-rigid registration algorithm for Digital Subtraction Angiography based on geometric features. Geometric feature points can be extracted and/or matched based on which triangle meshes are built to define the movement model. However, the geometric features can be dependent on the image content and might not be dense enough and/or accurate enough for dual energy image registration.

Certain exemplary embodiments can utilize a region based free-form registration algorithm to register breast Magnetic Resonance (MR) images. Regularly distributed control points can be used to control the movement of images for the alignment. The alignment can utilize the information in the image, rather than being based on the sparse feature points. Instead of using cubic B-splines to interpolate the control points, certain exemplary embodiments can use rectangularly spaced control points to control the freeform movement (FFD), which can have better localization and less computation. The performance might be almost the same when the control points are dense enough.

A Gaussian Pyramid structure can be used for the hierarchical searching strategy in certain exemplary embodiments to improve the speed and/or stability of the optimization procedure.

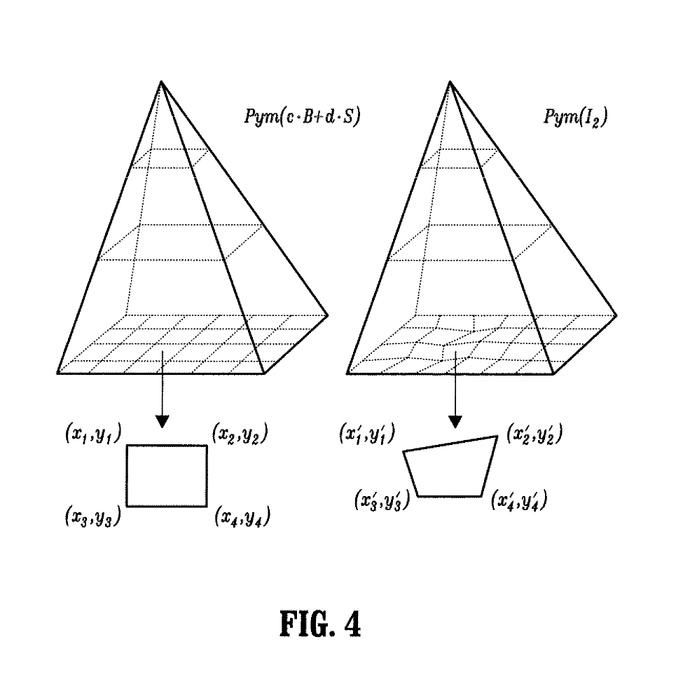

FIG. 4 is a diagram of exemplary Gaussian pyramid structures, which can be utilized in an exemplary movement model and the hierarchical optimization strategy.

The registration can be refined in a coarse-to-fine manner. When a near optimal solution for the coarse level is reached, certain exemplary embodiments can double the density of the control points and map it to the next finer level and further refine the control points based on the finer resolution image. Such a scheme can converge faster and might be less susceptible to local minima.

For each layer, certain exemplary embodiments can deform the bone B and soft tissue S (i.e. c·B+d·S) to match the observed image I₂ by the control points. For each control point, certain exemplary embodiments can search within a local search region to map each control point to a new coordinate in image I₂ and update the matching cost between c·B+d·S and I₂ within the affected regions (each control point affects the four rectangular regions around it). For subpixel accuracy, the search step can be set to be smaller than one pixel. In certain experiments, a value of 0.25 pixels was used as the search step at a finest level.

Suppose the control points on c·B+d·S are at (x₁, y₁) (x₂, y₂), (x₃, y₃), (x₄, y₄) and correspond to (x′₁, y′₁), (x′₂, y₂), (x′₃, y₃) and (x′₄, y′₄) in I₂ respectively. The pixel (xₚ, yₚ) inside the grid on c·B+d·S can be mapped to (x′ₚ, y′ₚ) in I₂ based on bilinear interpolation as follows:

$${[ {x}_{p}^{′} , {y}_{p}^{′} ]}^{T} = ( 1 - b ) \cdot {\overline{V}}_{1}^{T} + b \cdot {\overline{V}}_{2}^{T}$$

$$where$$

$$a = ( {y}_{p} - {y}_{1} ) / ( {y}_{2} - {y}_{1} ) , b = ( {x}_{p} - {x}_{1} ) / ( {x}_{3} - {x}_{1} )$$

$${\overline{V}}_{1} = [ 1 - a , a ] [ \begin{matrix}{x}_{1}^{′} & {y}_{1}^{′} \\ {x}_{2}^{′} & {y}_{2}^{′}\end{matrix} ] , {\overline{V}}_{2} = [ 1 - a , a ] [ \begin{matrix}{x}_{3}^{′} & {y}_{3}^{′} \\ {x}_{4}^{′} & {y}_{4}^{′}\end{matrix} ]$$

There are other ways to find the coordinate mapping, such as Homography matrix transformation. In certain experiments, bilinear geometric interpolations were used an appeared to be relatively stable and accurate compared to other transformation methods and potentially more computationally efficient.

Given pixel correspondence, certain exemplary embodiments can compute the cost function ∥I₂−c·T(B)−d·T(S)∥²+λ₂∥T− T̅∥² and find the control mesh that minimizes the cost function. The searching strategy for finding the optimal movement model T can be according to an exemplary Algorithm 2:

Algorithm 2: Hierarchical free-form non-rigid registration

```
In the Gaussian Pyramid, from coarse level 0 to fine level
N, do the following:
While k≦N do
  While ˜ stop do
    Update deformation Mₖⁱ⁺¹(x,y) for kth level
    for each control point Mₖⁱ(x,y) do
      Searching in its neighborhood to find the
      optimal control mesh that minimizes the
      matching cost.
      Update Mₖⁱ⁺¹(x,y) to the optimal position;
    end
    If ||Mₖⁱ⁺¹−Mₖⁱ||²≦εₖ, stop.
  end
  increase the density of control points to generate the
  initial Mₖ₊₁⁰(x,y), map Mₖⁱ⁺¹(x,y) to Mₖ₊₁⁰(x,y);
  increase k to k+1 and reset to 0;
end
```

Certain exemplary embodiments can be applied to the X-ray dual energy chest imaging. Experiments and comparisons on both real images and synthesized images showed the improvement of the proposed coupled registration method on registration accuracy and the reconstruction results.

For comparison, certain experiments implemented a separated method, which registered the dual images first and then used weighted subtraction to reconstruct the bone and soft tissue layers. To register the dual images, maximization of mutual information was used to guide the registration. The non-parametric density estimation technique for calculating the joint entropy between the dual images can, to some extent, handle the non-stationary mapping function between the dual images. Certain exemplary embodiments can replace the cost function in Equation (5) by attempting to maximize the mutual information between dual images and apply a similar hierarchical free-form registration method to align the dual images. Based on the registration results, weighted subtraction can be performed to separate the bone and soft tissue layers.

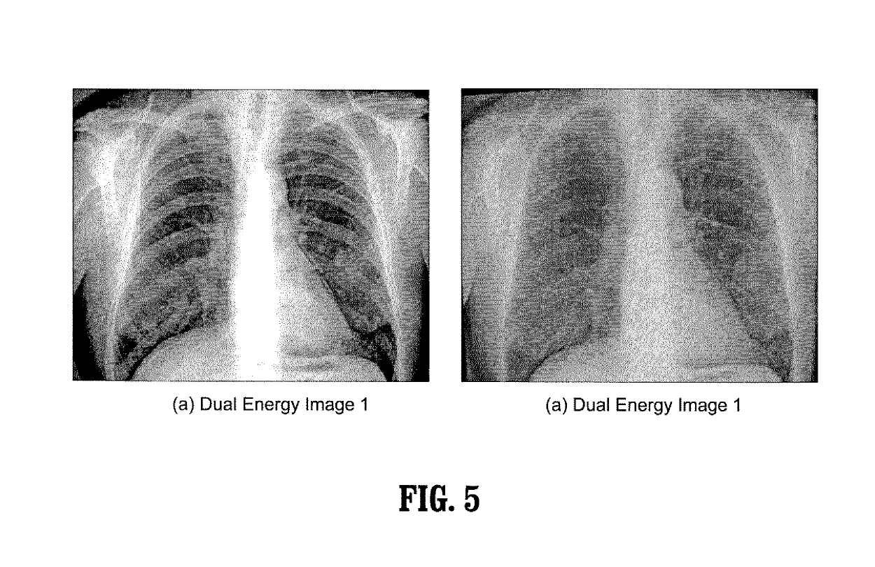

FIG. 5 is a set of exemplary images of a dual energy chest x-ray, which shows the dual images for chest imaging. FIG. 5 illustrates both bone and soft tissue structures overlaid in the images, which can make detecting lung nodules or other subtle details more difficult. Reconstruction of the bone and soft tissue specific images can increase a diagnostic value of the images.

Accurate registration can be desirable for good reconstruction of the bone and soft tissue. Otherwise, the image difference caused by registration error might become much more significant than the different characteristics of the bone and soft tissue.

Certain exemplary experiments compared the separated method with the coupled method. In the separated method, maximization of the mutual information appeared to handle the different appearances between the dual images reasonably well. But when the bone and soft tissue both had complex structures overlaid together, difficulties were experienced in estimating the mapping function robustly and accurately. Also, there was no scheme to refine the registration, even if the reconstruction results did not satisfy prior knowledge in the separated scheme.

To compare the results quantitatively, some tests were performed with synthesized motion to provide ground truth for accurate error analysis. The previous reconstructed bone and soft tissue were selected as ground truth to generate a pair of synthesized images. A transformation field that expands the lung region is applied to simulate an aspiration motion. Quantitative results and comparisons between the separated method and the coupled method are summarized in the following tables.

First the registration accuracy was computed. The estimated movement field T is compared with the ground truth (the synthesized motion). The average and maximum absolute registration error (in pixels) is listed as Table 1:

TABLE 1

| Error in T | Average | Max | Variance |
|---|---|---|---|
| Separated Method | 0.4690 | 1.4783 | 0.0815 |
| Coupled Method | 0.1490 | 1.0182 | 0.0182 |

In the experiments, the separated registration method achieved reasonably good results with maximum registration error of only 1.4783 pixels. However, the proposed coupled framework further improved the registration accuracy and provided consistently better results throughout the image. The mean and the variance of the registration error were smaller in the coupled method.

The error in the reconstructed bone and soft tissue layers were also compared. The absolute difference between the reconstructed results and the ground truth was normalized by the maximal intensity value of the bone and soft tissue images. The errors in different methods are listed in the following tables:

TABLE 2

| Error in B | Average | Max | Variance |
|---|---|---|---|
| Separated Method | 0.0217 | 0.4766 | 6.05e−4 |
| Coupled Method | 0.0080 | 0.2173 | 1.24e−4 |

TABLE 3

| Error in S | Average | Max | Variance |
|---|---|---|---|
| Separated Method | 0.0145 | 0.3179 | 2.69e−4 |
| Coupled Method | 0.0054 | 0.1451 | 5.49e−5 |

It is clearly shown that the coupled method generates consistently better reconstruction results.

Certain exemplary embodiments can comprise a coupled Bayesian framework for registering dual energy images and reconstruction of the overlaid bone and soft tissue layers jointly. Certain exemplary embodiments can provide an improvement over the separated scheme where multi-modality image registration is first applied and followed by a simple weighted subtraction to reconstruct the bone and soft tissue. More prior knowledge can be included in an exemplary framework and results in potentially more stable and physically meaningful results.

In certain exemplary embodiments, the coupled algorithm can be helpful for low-dose X-ray imaging to reduce radiation to the patients. In low-dose X-ray imaging, the signal/noise ratio drops significantly.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

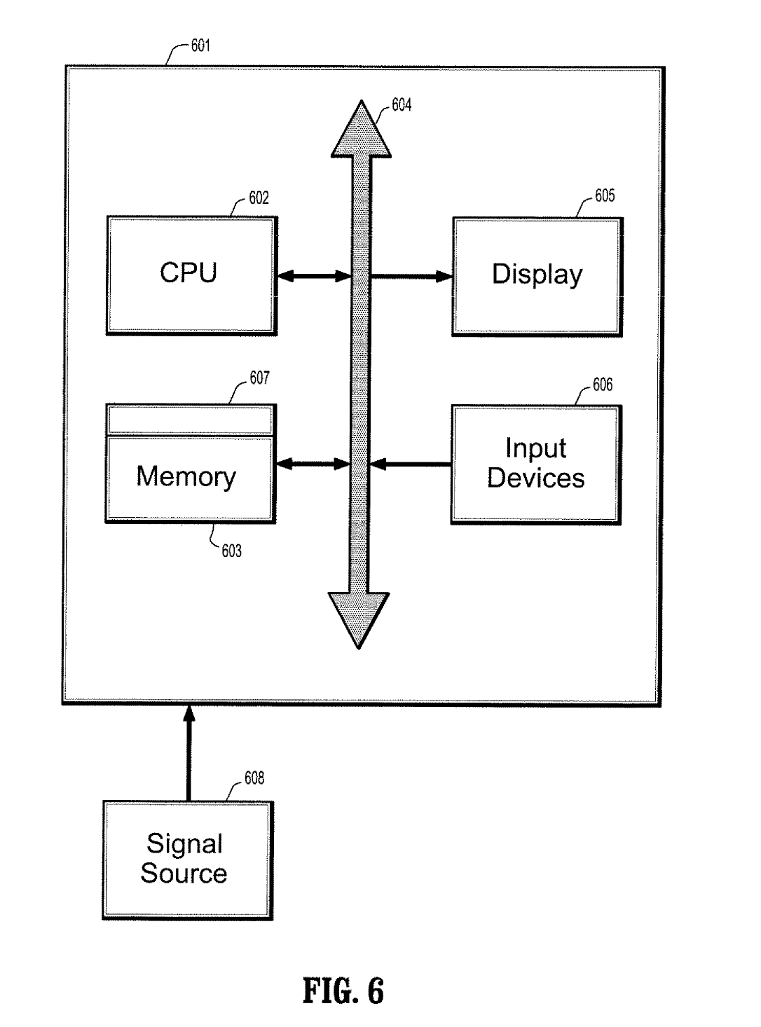

Referring to FIG. 6, according to an embodiment of the present disclosure, a computer system 601 for a coupled Bayesian framework for image registration in which the registration and reconstruction can reinforce each other can comprise, inter alia, a central processing unit (CPU) 602, a memory 603 and an input/output (I/O) interface 604. The computer system 601 is generally coupled through the I/O interface 604 to a display 605 and various input devices 606 such as a mouse and keyboard. The support circuits can include circuits such as cache, power supplies, clock circuits, and a communications bus. The memory 603 can include random access memory (RAM), read only memory (ROM), disk drive, tape drive, etc., or a combination thereof. The present invention can be implemented as a routine 607 that is stored in memory 603 and executed by the CPU 602 to process the signal from the signal source 608. As such, the computer system 701 is a general-purpose computer system that becomes a specific purpose computer system when executing the routine 707 of the present disclosure.

The computer platform 601 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method for a coupled Bayesian framework for image registration in which the registration and reconstruction can reinforce one another, it is noted that modifications and variations can be made by persons skilled in the art in light of the above teachings. It is therefore to be understood that changes may be made in embodiments of the present disclosure that are within the scope and spirit thereof.

What is claimed is:

1. A computer-implemented method for joint image registration and reconstruction of a plurality of images comprising:
providing the plurality of images;
modeling the plurality of images, including reconstructing bone and soft-tissue in respective images of the plurality of images;
performing a hierarchical free-form registration of models of the plurality of images to determine a jointly registered and reconstructed image with successive accuracy adjustment according to a registration error; and
outputting the registered and reconstructed image.

2. The computer-implemented method of claim 1, wherein outputting the registered and reconstructed image comprises one of displaying and storing to a computer-readable medium the registered and reconstructed image.

3. The computer-implemented method of claim 1, wherein the hierarchical free-form registration further comprises:
updating the deformation according to a control mesh;
determining an error for the deformation;
outputting the registered and reconstructed image upon determining that the error for the deformation is less than a threshold; and
increasing a density of the control mesh for updating the deformation.

4. The computer-implemented method of claim 1, wherein the modeling of the plurality of images, and the performing of the hierarchical free-form registration of the models are performed iteratively.

5. A method for joint image registration and reconstruction comprising:
receiving a first set of image data of a predetermined physiological structure of a patient, the first set of image data originated from an X-ray device operated at a first energy spectrum, the first set of image data originated during a first time interval;
receiving a second set of image data of the predetermined physiological structure of the patient, the second set of image data originated from the X-ray device operated at a second energy spectrum, the second set of image data originated during a second time interval, the second time interval distinct from the first time interval;
determining a mathematical representation of a bone layer of the physiological structure based upon prior knowledge;
determining a mathematical representation of a soft tissue layer of the physiological structure based upon prior knowledge;
adjusting the mathematical representation of the bone layer and the mathematical representation of the soft tissue layer until the adjustment of the mathematical representation of the bone layer is below a first predetermined threshold and the adjustment of the mathematical representation of the soft tissue layer is less than a second predetermined threshold based upon a movement of the patient in the second time interval relative to the first time interval;
adjusting the movement of the patient until the adjustment of the movement of the patient is below a third predetermined threshold based upon the adjusted mathematical representation of the bone layer and the adjusted mathematical representation of the soft tissue layer;
repeating the adjusting the adjusted mathematical representation of the bone layer and the mathematical representation of the soft tissue layer and the adjusting the movement of the patient until:
the adjustment of the mathematical representation of the bone layer is below the first predetermined threshold;
the adjustment of the mathematical representation of the soft tissue layer is less than the second predetermined threshold; and
the adjustment of the movement of the patient is below the third predetermined threshold; and
rendering an adjusted image of the predetermined physiological structure of the patient based upon the adjusted mathematical representation of the bone layer, the adjusted mathematical representation of the soft tissue layer, and the adjusted movement of the patient.

6. A method for joint image registration and reconstruction comprising:
providing a first set of image data of the predetermined physiological structure of the patient and a second set of image data of the predetermined physiological structure of the patient; and
automatically determining a renderable image of a predetermined physiological structure of a patient, the image determined based upon the first set of image data of the predetermined physiological structure of the patient, the first set of image data originated from an X-ray device operated at a first energy, the first set of image data originated during a first time interval, the image based upon the second set of image data of the predetermined physiological structure of the patient, the second set of image data originated from the X-ray device operated at a second energy, the second set of image data originated during a second time interval, the second time interval distinct from the first time interval, the image determined based upon an iteratively adjusted movement of the patient in the second time interval relative to the first time interval, an adjustment of a mathematical representation of a bone layer, and an adjustment of a mathematical representation of a soft tissue layer until the adjustment associated with optimizing the mathematical representation of the bone layer is below a first predetermined threshold and the adjustment associated with optimizing the mathematical representation of the soft tissue layer is less than a second predetermined threshold, based upon the movement of the patient.

7. The method of claim 6, further comprising repeating the adjustment of the mathematical representation of the soft tissue layer for a plurality of iteratively determined estimates of the mathematical representation of the bone layer.

8. The method of claim 6, further comprising repeating the adjustment of the mathematical representation of the bone layer for a plurality of iteratively determined estimates of the mathematical representation of the soft tissue layer.

9. The method of claim 6, further comprising repeatedly determining the mathematical representation of the bone layer based upon an iteration of the adjustment of the mathematical representation of the soft tissue layer.

10. The method of claim 6, further comprising repeatedly determining the mathematical representation of the soft tissue layer based upon an iteration of the adjustment of the mathematical representation of the bone layer.

11. The method of claim 6, further comprising determining the mathematical representation of the bone layer based upon prior knowledge about the statistical properties of the bone layer.

12. The method of claim 6, further comprising determining the mathematical representation of the soft tissue layer based upon prior knowledge about the statistical properties of the soft tissue layer.

13. The method of claim 6, further comprising determining the mathematical representation of the soft tissue layer and determining the mathematical representation of the bone layer based upon joint moments shared between the mathematical representation of the bone layer and the mathematical representation of the soft tissue layer.

14. The method of claim 6, wherein the adjusted movement of the patient is determined based upon the mathematical representation of the bone layer and the mathematical representation of the soft tissue layer.

15. The method of claim 6, wherein the adjusted movement of the patient is determined via an updated movement of a Gaussian pyramid.

16. The method of claim 6, wherein the adjusted movement of the patient is determined via a determination of a control mesh that attempts to minimize a cost.

17. The method of claim 6, wherein the adjusted movement of the patient is determined via a bilinear interpolation of control points of the mathematical representation of the bone layer and the mathematical representation of the soft tissue layer.

18. A computer readable medium embodying instructions executable by a processor to perform a method for joint image registration and reconstruction of a plurality of images, the method steps comprising:
providing the plurality of images;
modeling the plurality of images, including reconstructing bone and soft-tissue in respective images of the plurality of images;
performing a hierarchical free-form registration of models of the plurality of images to determine a jointly registered and reconstructed image with successive accuracy adjustment according to a registration error; and
outputting the registered and reconstructed image.

19. A system for joint image registration and reconstruction comprising:
a processing means for determining a renderable image of a predetermined physiological structure of a patient, the image determined based upon a first set of image data to of the predetermined physiological structure of the patient, the first set of image data originated from an X-ray device operated at a first energy, the first set of image data originated during a first time interval, the image based upon a second set of image data of the predetermined physiological structure of the patient, the second set of image data originated from the X-ray device operated at a second energy, the second set of image data originated during a second time interval, the second time interval distinct from the first time interval, the image determined based upon an iteratively adjusted movement of the patient in the second time interval relative to the first time interval and an adjustment of a mathematical representation of a bone layer and an adjustment of a mathematical representation of a soft tissue layer until the adjustment associated with optimizing the mathematical representation of the bone layer is below a first predetermined threshold and the adjustment associated with optimizing the mathematical representation of the soft tissue layer is less than a second predetermined threshold, based upon the movement of the patient; and
a user interface adapted to render the image.
